(19) United States
(12) Patent Application Publication
(10) Pub. No.: US 2016/0337257 A1
(43) Pub. Date: Nov. 17, 2016

(54) HEAD-OF-LINE BLOCKING (HOLB) MITIGATION IN COMMUNICATION DEVICES

(71) Applicant: QUALCOMM Incorporated, San Diego, CA (US)

(72) Inventors: Shaul Yohai Yifrach, Haifa (IL); Amit Gil, Zichron Yaakov (IL)

(21) Appl. No.: 14/713,028

(22) Filed: May 15, 2015

(51) Int. Cl. H04L 12/863

(52) U.S. Cl. CPC H04L 47/6205; H04L 47/623

(57) ABSTRACT

Aspects disclosed in the detailed description include head-of-line blocking (HOLB) mitigation in communication devices. Output queues employed by a communication device for transmitting data are susceptible to HOLB. In this regard, in one aspect, a queue monitoring logic is configured to detect HOLB by measuring and comparing a depth(s) of an output queue(s) against a queue-overflow threshold. If the depth(s) of the output queue(s) exceeds the queue-overflow threshold, a queue weight(s) of a corresponding input queue(s) is decreased to reduce data flow into the output queue(s), thus mitigating the HOLB in the output queue(s). In another aspect, the queue monitoring logic is configured to detect queue depletion by comparing the depth(s) of the output queue(s) against a queue-depletion threshold. By mitigating the HOLB and the data starvation in the output queue(s), it is possible to optimize the output queue(s) to achieve higher throughput and data integrity with lower power consumption.

### BACKGROUND

I. Field of the Disclosure

The technology of the disclosure relates generally to data transmissions in communication devices.

II. Background

Mobile communication devices have become increasingly common in current society. The prevalence of these mobile communication devices is driven in part by the many functions that are now enabled on such devices. Demand for such functions increases the processing capability requirements for the mobile communication devices. As a result, the mobile communication devices have become sophisticated mobile entertainment centers capable of processing a variety of data streams (e.g., voice, audio, videos, images, texts, etc.) simultaneously.

Although the mobile communication devices are capable of processing the variety of data streams simultaneously, the task of outputting the variety of data streams to one or more client devices in real time is more challenging. First of all, there is a limited bandwidth in available communications media (e.g., wireless spectrum) that must be shared by the variety of data streams. In addition, traffic patterns (e.g., constant bit rate versus variable bit rate, bursty versus sporadic, and so on) associated with the variety of data streams are unpredictable, making it difficult for even the most sophisticated traffic scheduler to work efficiently. Furthermore, the many features the mobile communication devices commonly support must be done under an increasingly stringent power consumption budget.

Data queuing is a commonly utilized mechanism in mobile communication devices to help organize and schedule the variety of data streams into output queues based on such factors as originations, destinations, and quality of service (QoS) priorities prior to transmitting data to the one or more client devices. In this regard, it is desirable to optimize the output queues to achieve higher efficiency, throughput, and data integrity with lower power consumption.

### SUMMARY OF THE DISCLOSURE

Aspects disclosed in the detailed description include head-of-line blocking (HOLB) mitigation in communication devices. Output queues employed by a communication device for transmitting data are susceptible to HOLB. In this regard, in one aspect, a queue monitoring logic is configured to detect HOLB by measuring and comparing a depth(s) of an output queue(s) against a queue-overflow threshold. If the depth(s) of the output queue(s) exceeds the queue-overflow threshold, a queue weight(s) of a corresponding input queue(s) is decreased to reduce data flow into the output queue(s), thus mitigating the HOLB in the output queue(s). In another aspect, the queue monitoring logic is also configured to detect queue depletion by comparing the depth(s) of the output queue(s) against a queue-depletion threshold. If the depth(s) of the output queue(s) falls below the queue-depletion threshold, the queue weight(s) of the corresponding input queue(s) is increased to boost data flow into the output queue(s), thus preventing the data starvation in the output queue(s). By mitigating the HOLB and the data starvation in the output queue(s), it is possible to optimize the output queue(s) to achieve higher throughput and data integrity with lower power consumption.

In this regard, in one aspect, a transmission control logic for mitigating HOLB in a communication device is provided. The transmission control logic comprises a queue monitoring logic communicatively coupled to one or more output queues in a communication device. The transmission control logic also comprises a queue weight determination logic communicatively coupled to one or more input queues configured to provide one or more output data streams to the one or more output queues, respectively. For each of the one or more output queues, the queue monitoring logic is configured to measure a respective queue depth of the output queue. For each of the one or more output queues, the queue monitoring logic is also configured to compare the respective queue depth against a threshold to determine a state of the output queue. For each of the one or more output queues, the queue weight determination logic is configured to adjust a respective output data stream coupled to the output queue in response to the determination of the state of the output queue.

In another aspect, a means for mitigating HOLB in a communication device is provided. The means for mitigating HOLB in a communication device comprises a means for monitoring one or more output queues in a communication device. The means for mitigating HOLB in a communication device also comprises a means for controlling one or more input queues configured to provide one or more output data streams to the one or more output queues, respectively. For each of the one or more output queues, the means for monitoring one or more output queues in a communication device is configured to measure a respective queue depth of the output queue. For each of the one or more output queues, the means for monitoring one or more output queues in a communication device is also configured to compare the respective queue depth against a threshold to determine a state of the output queue. For each of the one or more output queues, the means for controlling one or more input queues is configured to adjust a respective output data stream coupled to the output queue in response to the determination of the state of the output queue.

In another aspect, a method for mitigating HOLB in a communication device is provided. The method comprises measuring a respective queue depth of an output queue among one or more output queues comprised in a communication device. The method also comprises comparing the respective queue depth against a threshold to determine a state of the output queue. The method also comprises adjusting a respective output data stream among one or more output data streams coupled to the output queue in response to the determination of the state of the output queue.

### BRIEF DESCRIPTION OF THE FIGURES

FIG. 1 is a schematic diagram of an exemplary communication device employing one or more output queues for communication with one or more client devices;

FIG. 2 is a schematic diagram of an exemplary communication device employing a transmission control logic for detecting and mitigating head-of-line blocking (HOLB) and data starvation in the one or more output queues in FIG. 1;

FIG. 3 is a flowchart illustrating an exemplary queue depth monitoring process employed by a queue monitoring logic in the transmission control logic in FIG. 2 for reliable detection of HOLB and data starvation in the one or more output queues in FIG. 1;

FIG. 4 is a schematic diagram of an exemplary queue weight determination logic configured to increase or decrease a respective queue weight for a respective input queue among one or more input queues;

FIG. 5 is an exemplary output queue depth-versus-time (QD-Time) plot illustrating an output queue depth variation over time in response to adjustments to a queue weight of a corresponding input queue by the transmission control logic in FIG. 2; and

FIG. 6 illustrates an example of a processor-based system that can support the transmission control logic in FIG. 2 for HOLB mitigation.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include head-of-line blocking (HOLB) mitigation in communication devices. Output queues employed by a communication device for transmitting data are susceptible to HOLB. In this regard, in one aspect, a queue monitoring logic is configured to detect HOLB by measuring and comparing a depth(s) of an output queue(s) against a queue-overflow threshold. If the depth(s) of the output queue(s) exceeds the queue-overflow threshold, a queue weight(s) of a corresponding input queue(s) is decreased to reduce data flow into the output queue(s), thus mitigating the HOLB in the output queue(s). In another aspect, the queue monitoring logic is also configured to detect queue depletion by comparing the depth(s) of the output queue(s) against a queue-depletion threshold. If the depth(s) of the output queue(s) falls below the queue-depletion threshold, the queue weight(s) of the corresponding input queue(s) is increased to boost data flow into the output queue(s), thus preventing the data starvation in the output queue(s). By mitigating the HOLB and the data starvation in the output queue(s), it is possible to optimize the output queue(s) to achieve higher throughput and data integrity with lower power consumption.

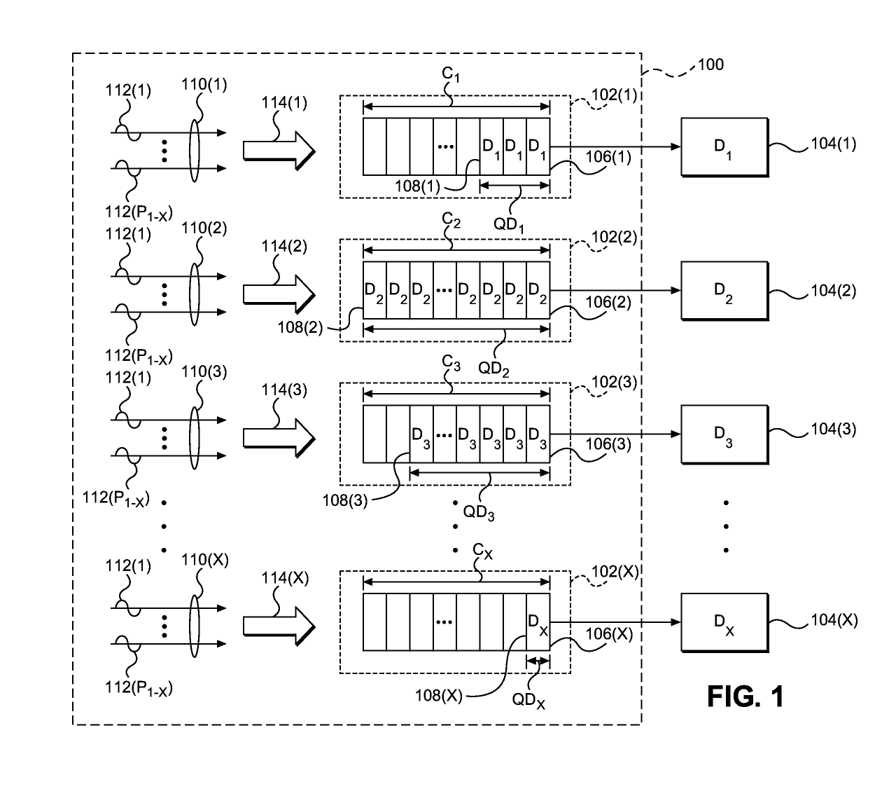

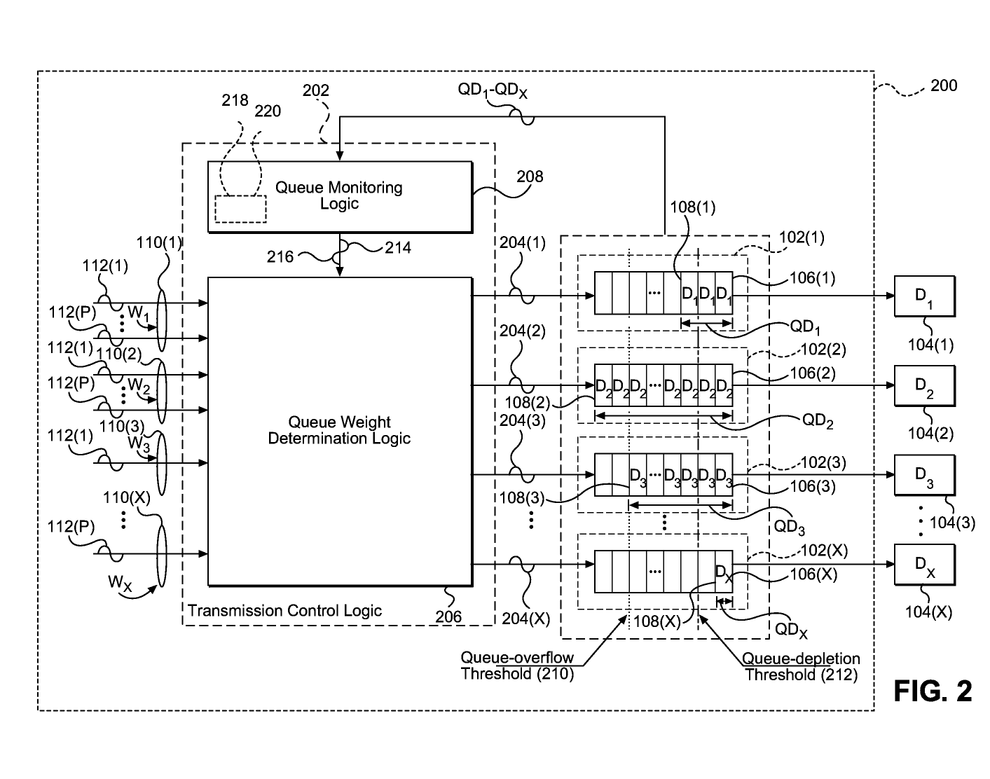

Before discussing aspects of HOLB mitigation in communication devices that include specific aspects of the present disclosure, a brief overview of a conventional output queue operation is provided in FIG. 1. The discussion of specific exemplary aspects of the HOLB mitigation in communication devices starts below with reference to FIG. 2.

In this regard, FIG. 1 is a schematic diagram of an exemplary communication device 100 employing one or more output queues 102(1)-102(X) for communication with one or more client devices 104(1)-104(X), respectively. In a non-limiting example, the one or more client devices 104(1)-104(X) may be external devices (e.g., mobile communication devices) or internal devices such as integrated circuits (ICs).

With reference to FIG. 1, the one or more output queues 102(1)-102(X) have respective capacities C₁-C_{X} that determine the maximum number of data units (e.g., packet, byte, symbol, etc.) each of the output queues 102(1)-102(X) can store. For the convenience of discussion and illustration, the capacities C₁-C_{X} are hereinafter referenced in units of data packets. The one or more output queues 102(1)-102(X) comprise one or more head-of-line (HOL) packets 106(1)-106(X) and one or more end-of-line (EOL) packets 108(1)-108(X), respectively. In a non-limiting example, the one or more output queues 102(1)-102(X) are first-in-first-out (FIFO) queues wherein the one or more HOL packets 106(1)-106(X) are transmitted before the one or more EOL packets 108(1)-108(X), respectively. The respective distances between the one or more EOL packets 108(1)-108(X) and the one or more HOL packets 106(1)-106(X) determine one or more queue depths QD₁-QD_{X} of the one or more output queues 102(1)-102(X). For instance, in the output queue 102(1), the queue depth QD₁ is determined by the distance between the EOL packet 108(1) and the HOL packet 106(1), the queue depth QD₂ in the output queue 102(2) is determined by the distance between the EOL packet 108(2) and the HOL packet 106(2), and so on.

With continuing reference to FIG. 1, each of one or more input queues 110(1)-110(X) receives one or more input data streams 112(1)-112(P_{1-X}), wherein P_{1-X} indicates that P may be different finite positive integers among the one or more input queues 110(1)-110(X). In a non-limiting example, the one or more input queues 110(1)-110(X) may be one or more logical queues each comprising the one or more input data streams 112(1)-112(P_{1-X}). The one or more input queues 110(1)-110(X) are further configured to feed one or more output data streams 114(1)-114(X) to the one or more output queues 102(1)-102(X) for transmission to the one or more client devices 104(1)-104(X), respectively.

In one non-limiting example, the client device 104(2) may be configured to enter periodically a sleep period (not shown) to reduce power consumption. The client device 104(2) is thus unable to receive any data from the output queue 102(2) during the sleep period. As such, the HOL packet 106(2) must be held in the output queue 102(2), causing a HOLB in the output queue 102(2). The input queue 110(2), however, may be unaware of the HOLB in the output queue 102(2) and continue to feed the output data stream 114(2) to the output queue 102(2). Consequently, an overflow will occur in the output queue 102(2) when the queue depth QD₂ reaches the capacity C₂ and causes subsequent data packets in the output data stream 114(2) to be lost, thus compromising data integrity in the output queue 102(2).

In another non-limiting example, the HOL packet 106(X) is the same packet as the EOL packet 108(X) in the output queue 102(X). As a result, the output queue 102(X) becomes empty after transmitting the HOL packet 106(X) to the client device 104(X). If the input queue 110(X) does not replenish the output queue 102(X) in time, a data starvation will occur and data throughput of the output queue 102(X) is reduced. Hence, it is desirable to detect and mitigate the HOLB and the data starvation in the one or more output queues 102(1)-102(X) to ensure higher data integrity and data throughput.

In this regard, FIG. 2 is a schematic diagram of an exemplary communication device 200 employing a transmission control logic 202 for detecting and mitigating HOLB and data starvation in the one or more output queues 102(1)-102(X) in FIG. 1. Common elements between FIGS. 1 and 2 are shown therein with common element numbers and will not be re-described herein.

With reference to FIG. 2, a queue scheduler (not shown) in the communication device 200 schedules the one or more input queues 110(1)-110(X) to provide one or more output data streams 204(1)-204(X) to the one or more output queues 102(1)-102(X), respectively, based on a weighted round robin (WRR) scheduling scheme. Under the WRR scheduling scheme, the one or more input queues 110(1)-110(X) are assigned queue weights W₁-W_{X} that proportionally determine transmission opportunities for the one or more input queues 110(1)-110(X), respectively. For example, the transmission opportunity of the input queue 110(1) equals the respective queue weight W₁ divided by a sum of the queue weights W₁-W_{X}. In other words, the respective transmission opportunity of the input queue 110(1) equals (W₁/Σᵢ₌₁^{X}Wᵢ). Likewise, the respective transmission opportunity of the input queue 110(2) equals (W₂/Σᵢ₌₁^{X}Wᵢ), and so on. If the queue weights W₁-W_{X} are all equal, the one or more input queues 110(1)-110(X) will all receive the same one-Xth (1/X) transmission opportunity. In this regard, it is possible to increase or decrease the one or more output data streams 204(1)-204(X) by increasing or decreasing the queue weights W₁-W_{X} of the one or more input queues 110(1)-110(X), respectively.

For the convenience of reference, the output queue 102(Y), which refers to any output queue among the one or more output queues 102(1)-102(X), is discussed hereinafter as a non-limiting example. The corresponding queue depth QD_{Y}, output data stream 204(Y), input queue 110(Y), and queue weight W_{Y} are also referenced herein in association with the output queue 102(Y).

With continuing reference to FIG. 2, the transmission control logic 202 comprises a queue weight determination logic 206, which is communicatively coupled to the one or more input queues 110(1)-110(X), and a queue monitoring logic 208. The queue monitoring logic 208 is communicatively coupled to the one or more output queues 102(1)-102(X) and configured to detect HOLBs and/or data starvations in the one or more output queues 102(1)-102(X). For each of the one or more output queues 102(1)-102(X), the queue monitoring logic 208 measures a respective queue depth among the queue depths QD₁-QD_{X} and compares the respective queue depth against a threshold (not shown) to determine a state of the output queue 102(Y) among the one or more output queues 102(1)-102(X). The queue weight determination logic 206 is configured to adjust a respective output data stream 204(Y) among the one or more output data streams 204(1)-204(X) coupled to the output queue 102(Y) in response to the determination of the state of the output queue 102(Y). The threshold comprises a queue-overflow threshold 210 and a queue-depletion threshold 212. In a non-limiting example, the queue-overflow threshold 210 and the queue-depletion threshold 212 may be the same or different among the one or more output queues 102(1)-102(X).

If the respective queue depth QD_{Y} is greater than the queue-overflow threshold 210, this may be a warning sign of a HOLB in the output queue 102(Y). Thus, if the queue depth QD_{Y} is greater than the queue-overflow threshold 210, the queue monitoring logic 208 provides a respective queue-overflow indication 214 to the queue weight determination logic 206. For example, the respective queue depth QD₂ of the output queue 102(2) is greater than the respective queue-overflow threshold 210. Therefore, the queue monitoring logic 208 will generate the respective queue-overflow indication 214 for the output queue 102(2). In response to receiving the respective queue-overflow indication 214, the queue weight determination logic 206 decreases the respective output data stream 204(2) coupled to the output queue 102(2) to mitigate the HOLB in the output queue 102(2). As previously discussed, the queue weight determination logic 206 may decrease the respective output data stream 204(2) by decreasing the respective queue weight W₂ of the respective input queue 110(2).

If the respective queue depth QD_{Y} is less than the queue-depletion threshold 212, this may be a warning sign of a data starvation in the respective output queue 102(Y). Thus, if the queue depth QD_{Y} is less than the queue-depletion threshold 212, the queue monitoring logic 208 provides a respective queue-depletion indication 216 to the queue weight determination logic 206. For example, the respective queue depth QD_{X} of the output queue 102(X) is less than the respective queue-depletion threshold 212. As a result, the queue monitoring logic 208 generates the respective queue-depletion indication 216 for the output queue 102(X). In response to receiving the respective queue-depletion indication 216, the queue weight determination logic 206 increases the respective output data stream 204(X) coupled to the output queue 102(X) to prevent data starvation in the output queue 102(X). As previously discussed, the queue weight determination logic 206 may increase the respective output data stream 204(X) by increasing the respective queue weight W_{X} of the respective input queue 110(X).

However, the queue monitoring logic 208 will not generate the respective queue-overflow indication 214 for the output queue 102(X) if the respective queue depth QD_{X} is less than or equal to the queue-overflow threshold 210. Likewise, the queue monitoring logic 208 will not generate the respective queue-depletion indication 216 for the output queue 102(X) if the respective queue depth QD_{X} is greater than or equal to the queue-depletion threshold 212. For example, the queue monitoring logic 208 will not generate the respective queue-overflow indication 214 and the respective queue-depletion indication 216 for the output queue 102(1) because the respective queue depth QD₁ is neither greater than the queue-overflow threshold 210 nor less than the queue-depletion threshold 212. The same is true for the output queue 102(3) even though the respective queue depth QD₃ is shown as being equal to the queue-overflow threshold 210. Hence, by detecting the HOLBs and the data starvations in the one or more output queues 102(1)-102(X) based on the queue-overflow threshold 210 and the queue-depletion threshold 212, it is possible to adjust timely the one or more output data streams 204(1)-204(X) to mitigate the HOLBs and the data starvations in the output queues 102(1)-102(X).

With continuing reference to FIG. 2, traffic patterns of the one or more output data streams 204(1)-204(X) may be bursty or occur at variable data rates. Taking the output queue 102(X) as an example, the output queue 102(X) could be instantaneously filled up by a large data burst received after the queue monitoring logic 208 has generated the respective queue-depletion indication 216 and before the queue monitoring logic 208 takes the next measurement of the respective queue depth QD_{X}. If the queue weight determination logic 206 acts immediately on the respective queue-depletion indication 216 to increase the respective output data stream 204(X), an overflow may happen in the output queue 102(X) as a result. It is also possible that after the queue monitoring logic 208 has generated the respective queue-overflow indication 214, the client device 104(2) exits from the sleep period and flushes out the output queue 102(2). In this case, if the queue weight determination logic 206 acts immediately on the respective queue-overflow indication 214 to decrease the respective output data stream 204(2), a data starvation may happen in the output queue 102(2) as a result. To prevent the premature change in the output data streams 204(1)-204(X) as described above, a queue-overflow counter 218 and a queue-depletion counter 220 are provided in the queue monitoring logic 208 to improve reliability of the respective queue-overflow indication 214 and the respective queue-depletion indication 216 using a predetermined hysteresis value.

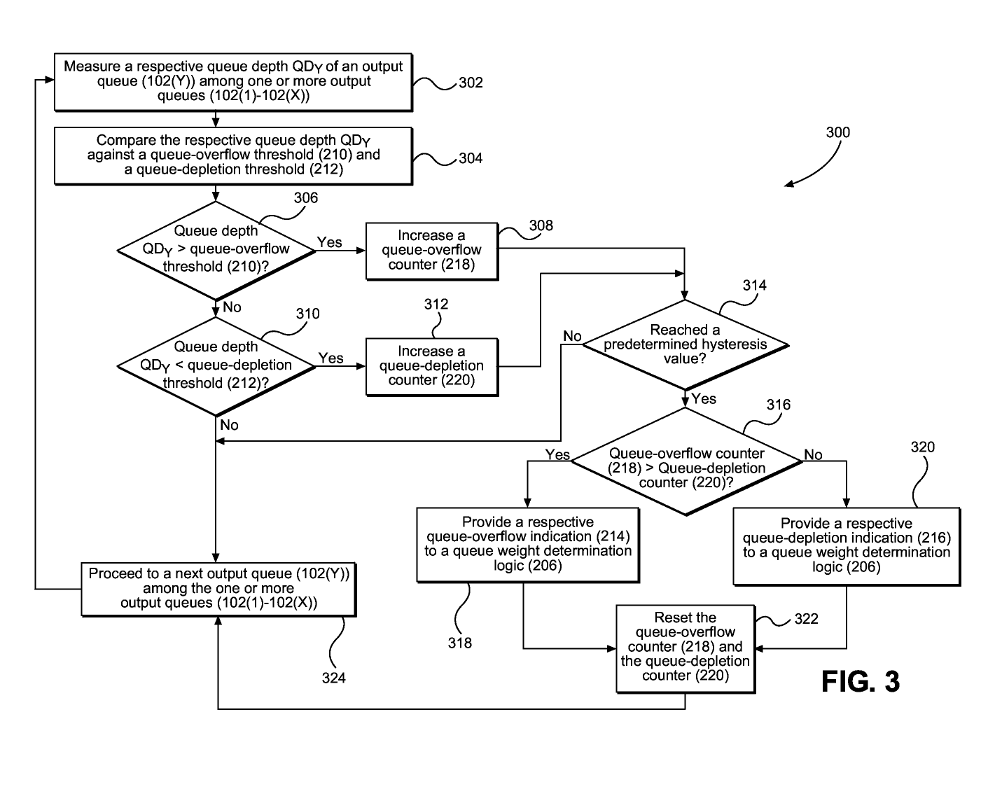

In this regard, FIG. 3 is a flowchart illustrating an exemplary queue depth monitoring process 300 employed by the queue monitoring logic 208 for reliable detection of HOLB and data starvation in the one or more output queues 102(1)-102(X). Elements of FIGS. 1 and 2 are referenced in connection to FIG. 3 and will not be re-described herein.

For each of the one or more output queues 102(1)-102(X), the queue monitoring logic 208 first measures the respective queue depth QD_{Y} among the one or more queue depths QD₁-QD_{X} of the output queue 102(Y) among the one or more output queues 102(1)-102(X) (block 302). The queue monitoring logic 208 then compares the respective queue depth QD_{Y} against the queue-overflow threshold 210 and the queue-depletion threshold 212 (block 304). The queue monitoring logic 208 first determines whether the respective queue depth QD_{Y} is greater than the queue-overflow threshold 210 (block 306). If the respective queue depth QD_{Y} is greater than the queue-overflow threshold 210, the queue monitoring logic 208 increases the queue-overflow counter 218 (block 308). If the respective queue depth QD_{Y} is less than or equal to the queue-overflow threshold 210, the queue monitoring logic 208 then determines whether the respective queue depth QD_{Y} is less than the queue-depletion threshold 212 (block 310). If the respective queue depth is less than the queue-depletion threshold 212, the queue monitoring logic 208 increases the queue-depletion counter 220 (block 312). The queue monitoring logic 208 then checks whether the predetermined hysteresis value has been reached (block 314). In a non-limiting example, the predetermined hysteresis value may be set as a hysteresis timer whereby the queue monitoring logic 208 generates the respective queue-overflow indication 214 or the respective queue-depletion indication 216 at expiration of the hysteresis timer. In another non-limiting example, the predetermined hysteresis value may be set as a hysteresis counter whereby the queue monitoring logic 208 generates the respective queue-overflow indication 214 or the respective queue-depletion indication 216 when the queue-overflow counter 218 or the queue-depletion counter 220 has the same value as the hysteresis counter. By implementing the predetermined hysteresis value, reliability of the respective queue-overflow indication 214 and the respective queue-depletion indication 216 may be improved.

With continuing reference to FIG. 3, if the predetermined hysteresis value is reached, the queue monitoring logic 208 then compares the values of the queue-overflow counter 218 and the queue-depletion counter 220 (block 316). If the value of the queue-overflow counter 218 is greater than the value of the queue-depletion counter 220, the queue monitoring logic 208 provides the respective queue-overflow indication 214 to the queue weight determination logic 206 (block 318). If the value of the queue-overflow counter 218 is less than the value of the queue-depletion counter 220, the queue monitoring logic 208 provides the respective queue-depletion indication 216 to the queue weight determination logic 206 (block 320). The queue-overflow counter 218 and the queue-depletion counter 220 are reset to zero after the queue monitoring logic 208 generates the respective queue-overflow indication 214 or the respective queue-depletion indication 216 (block 322). Subsequently, the queue monitoring logic 208 moves to another output queue 102(Y) among the one or more output queues 102(1)-102(X) and repeats the queue depth monitoring process 300 (block 324). If the predetermined hysteresis value is not reached in block 314, the queue monitoring logic 208 also moves to another output queue 102(Y) among the one or more output queues 102(1)-102(X) and repeats the queue depth monitoring process 300 (block 324).

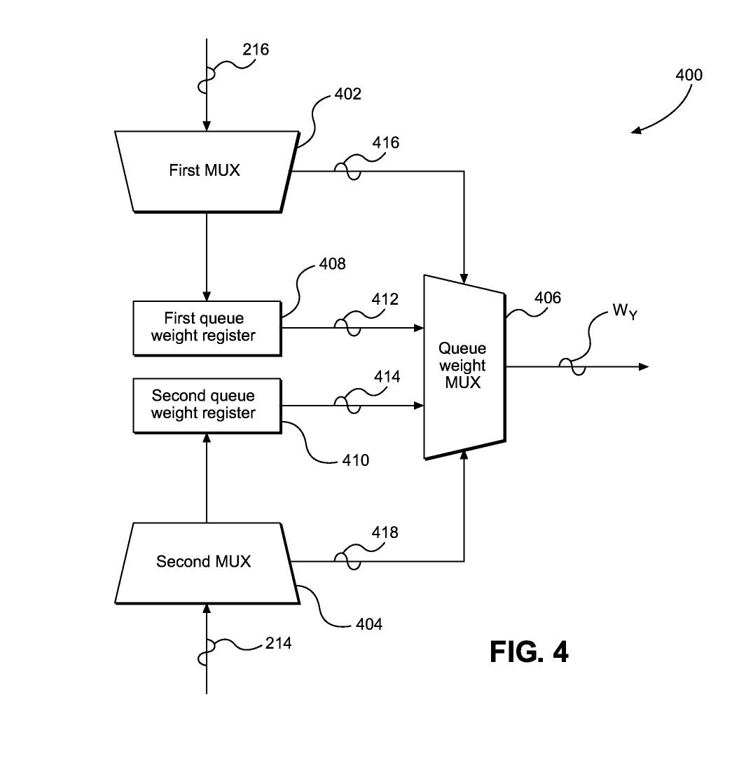

In addition to employing the predetermined hysteresis value in the queue monitoring logic 208, it is also possible to introduce a second level of hysteresis in the queue weight determination logic 206. In this regard, FIG. 4 is a schematic diagram of an exemplary queue weight determination logic 400 configured to increase or decrease a respective queue weight among the one or more queue weights W₁-W_{X} for a respective input queue among the one or more input queues 110(1)-110(X). Elements in FIG. 2 are referenced in connection with FIG. 4 and will not be re-described herein. The input queue 110(Y), which refers to any of the one or more input queues 110(1)-110(X), is discussed herein as a non-limiting example.

The queue weight determination logic 400 comprises a first multiplexer (MUX) 402, a second MUX 404, and a queue weight MUX 406. The queue weight determination logic 400 also comprises a first queue weight register 408 and a second queue weight register 410. In a non-limiting example, the one or more input queues 110(1)-110(X) may be initially assigned equal queue weights W₁-W_{X}, respectively. In this regard, each of the one or more input queues 110(1)-110(X) has a respective queue weight W_{Y} equal to one-over-X (1/X). Accordingly, both the first queue weight register 408 and the second queue weight register 410 have the initial values of 1/X.

With continuing reference to FIG. 4, the first MUX 402 is configured to increase the first queue weight register 408 in response to receiving the respective queue-depletion indication 216. Similarly, the second MUX 404 is configured to decrease the second queue weight register 410 in response to receiving the respective queue-overflow indication 214. The values of the first queue weight register 408 and the second queue weight register 410 are provided to the queue weight MUX 406 as a first queue weight input signal 412 and a second queue weight input signal 414, respectively. The queue weight MUX 406 determines the respective queue weight W_{Y} according to the first queue weight register 408 if the queue weight MUX 406 receives a first control signal 416 from the first MUX 402. In contrast, the queue weight MUX 406 determines the respective queue weight W_{Y} according to the second queue weight register 410 if the queue weight MUX 406 receives a second control signal 418 from the second MUX 404. In a non-limiting example, the first MUX 402 may be configured to provide the first control signal 416 after receiving a first threshold number of the respective queue-depletion indication 216. Likewise, the second MUX 404 may be configured to provide the second control signal 418 after receiving a second threshold number of the respective queue-overflow indication 214. The first threshold number and the second threshold number serve as the second level of hysteresis in the queue weight determination logic 400, thus further enhancing the reliability of the transmission control logic 202.

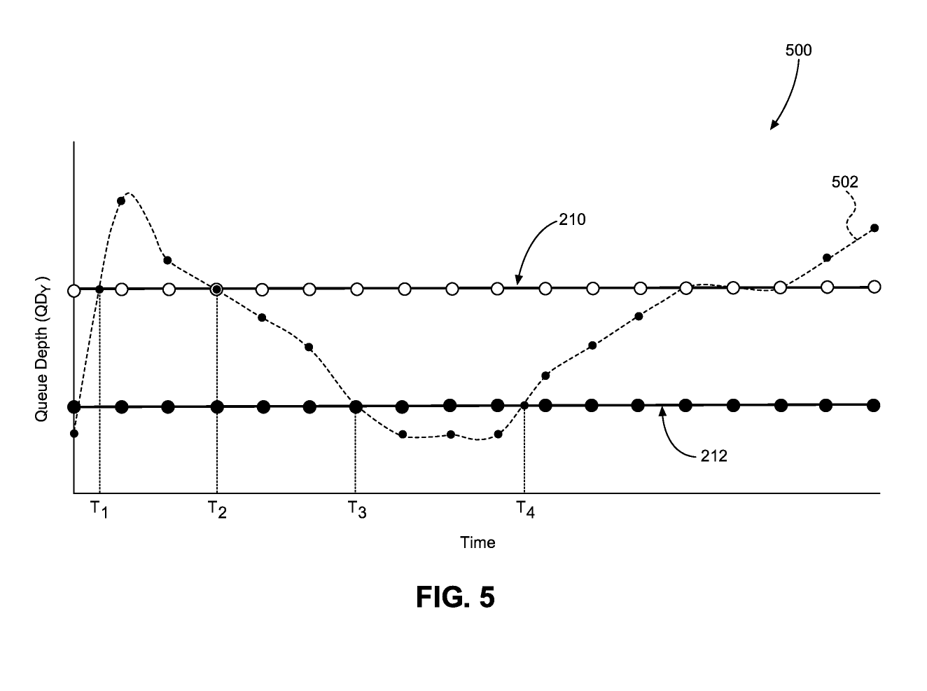

To illustrate the effectiveness of the transmission control logic 202 in FIG. 2 for detecting and mitigating HOLB and data starvation in the one or more output queues 102(1)-102(X), FIG. 5 is provided. In this regard, FIG. 5 is an exemplary output queue depth-versus-time (QD-Time) plot 500 illustrating the queue depth QD_{Y} variation over time in response to adjustment to the queue weight W_{Y} (not shown) of the input queue 110(Y) (not shown) by the transmission control logic 202 (not shown). Elements of FIG. 2 are referenced in connection with FIG. 5 and will not be re-described herein.

With reference to FIG. 5, the QD-Time plot 500 includes a QD variation curve 502. As illustrated by the QD variation curve 502, the queue monitoring logic 208 (not shown) detects that the queue depth QD_{Y} exceeds the queue-overflow threshold 210 at time T₁. In response, the queue weight determination logic 206 (not shown) reduces the queue weight W_{Y} of the input queue 110(Y) to reduce the output data stream 204(Y) (not shown). As a result, the queue depth QD_{Y} returns to normal (e.g., above the queue-depletion threshold 212 and below the queue-overflow threshold 210) at time T₂. At time T₃, the queue monitoring logic 208 detects that the queue depth QD_{Y} has dropped below the queue-depletion threshold 212. Hence, the queue weight determination logic 206 increases the queue weight W_{Y} of the input queue 110(Y). As a result, the output data stream 204(Y) increases and the queue depth QD_{Y} returns to normal at time T₄. In this regard, the transmission control logic 202 is effective in detecting and mitigating HOLB and data starvation in the one or more output queues 102(1)-102(X).

HOLB mitigation in communication devices according to aspects disclosed herein may be provided in or integrated into any processor-based device. Examples, without limitation, include a set top box, an entertainment unit, a navigation device, a communication device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

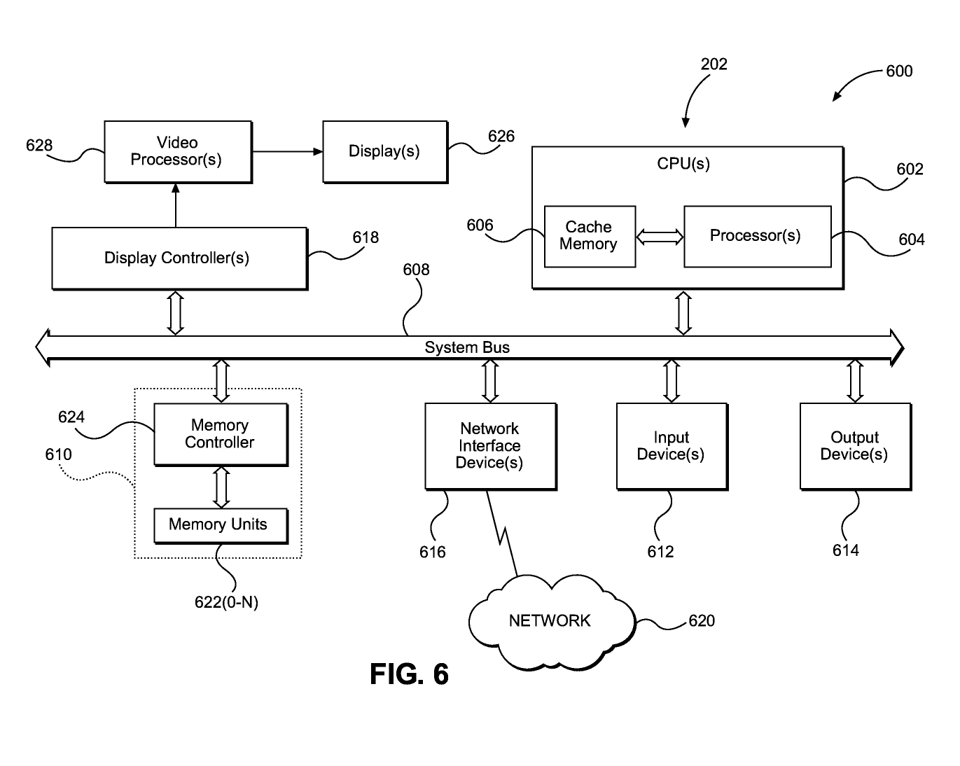

In this regard, FIG. 6 illustrates an example of a processor-based system 600 that can support the transmission control logic 202 illustrated in FIG. 2 for HOLB and data starvation detection and mitigation. In this example, the processor-based system 600 includes one or more central processing units (CPUs) 602, each including one or more processors 604. The CPU(s) 602 may have cache memory 606 coupled to the processor(s) 604 for rapid access to temporarily stored data. The CPU(s) 602 is coupled to a system bus 608. As is well known, the CPU(s) 602 communicates with these other devices by exchanging address, control, and data information over the system bus 608. Although not illustrated in FIG. 6, multiple system buses 608 could be provided, wherein each system bus 608 constitutes a different fabric.

Other master and slave devices can be connected to the system bus 608. As illustrated in FIG. 6, these devices can include a memory system 610, one or more input devices 612, one or more output devices 614, one or more network interface devices 616, and one or more display controllers 618, as examples. The input device(s) 612 can include any type of input device, including but not limited to input keys, switches, voice processors, etc. The output device(s) 614 can include any type of output device, including but not limited to audio, video, other visual indicators, etc. The network interface device(s) 616 can be any device configured to allow exchange of data to and from a network 620. The network 620 can be any type of network, including but not limited to a wired or wireless network, a private or public network, a local area network (LAN), a wireless local area network (WLAN), a wide area network (WAN), a BLUETOOTH™ network, or the Internet. The network interface device(s) 616 can be configured to support any type of communications protocol desired. The memory system 610 can include one or more memory units 622(0-N) and a memory controller 624.

The CPU(s) 602 may also be configured to access the display controller(s) 618 over the system bus 608 to control information sent to one or more displays 626. The display controller(s) 618 sends information to the display(s) 626 to be displayed via one or more video processors 628, which process the information to be displayed into a format suitable for the display(s) 626. The display(s) 626 can include any type of display, including but not limited to a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A transmission control logic for mitigating head-of-line blocking (HOLB) in a communication device, comprising:
a queue monitoring logic communicatively coupled to one or more output queues in a communication device; and
a queue weight determination logic communicatively coupled to one or more input queues configured to provide one or more output data streams to the one or more output queues, respectively;
for each of the one or more output queues:
the queue monitoring logic is configured to:
measure a respective queue depth of the output queue; and
compare the respective queue depth against a threshold to determine a state of the output queue; and
the queue weight determination logic is configured to adjust a respective output data stream coupled to the output queue in response to the determination of the state of the output queue.

2. The transmission control logic of claim 1, wherein for each of the one or more output queues:
the queue monitoring logic is configured to:
compare the respective queue depth against a queue-overflow threshold; and
provide a respective queue-overflow indication to the queue weight determination logic if the respective queue depth is greater than the queue-overflow threshold; and
the queue weight determination logic is configured to decrease the respective output data stream coupled to the output queue in response to receiving the respective queue-overflow indication.

3. The transmission control logic of claim 2, wherein for each of the one or more output queues:
the queue monitoring logic is configured to:
compare the respective queue depth against a queue-depletion threshold; and
provide a respective queue-depletion indication to the queue weight determination logic if the respective queue depth is less than the queue-depletion threshold; and
the queue weight determination logic is configured to increase the respective output data stream coupled to the output queue in response to receiving the respective queue-depletion indication.

4. The transmission control logic of claim 1, wherein the one or more output queues are first-in-first-out (FIFO) queues.

5. The transmission control logic of claim 3, wherein the respective queue depth of the output queue comprises a plurality of respective queue depths measured periodically by the queue monitoring logic.

6. The transmission control logic of claim 5, wherein the queue monitoring logic is further configured to:
for each of the plurality of respective queue depths:
increase a queue-overflow counter if the respective queue depth is greater than the queue-overflow threshold; and
increase a queue-depletion counter if the respective queue depth is less than the queue-depletion threshold; and
if the queue-overflow counter or the queue-depletion counter is greater than or equal to a predetermined hysteresis value:
generate the respective queue-overflow indication if the queue-overflow counter is greater than the queue-depletion counter; and
generate the respective queue-depletion indication if the queue-overflow counter is less than the queue-depletion counter.

7. The transmission control logic of claim 6, wherein the queue monitoring logic is further configured to reset the queue-overflow counter and the queue-depletion counter after generating the respective queue-overflow indication or the respective queue-depletion indication.

8. The transmission control logic of claim 3, wherein the one or more input queues are configured to provide the one or more output data streams based on a weighted round robin (WRR) scheduling scheme.

9. The transmission control logic of claim 8, wherein the one or more input queues are assigned one or more queue weights, respectively.

10. The transmission control logic of claim 9, wherein the queue weight determination logic is further configured to:
decrease the respective output data stream coupled to the output queue by decreasing a respective queue weight associated with a respective input queue among the one or more input queues, wherein the respective input queue is configured to provide the respective output data stream; and
increase the respective output data stream coupled to the output queue by increasing the respective queue weight associated with the respective input queue configured to provide the respective output data stream.

11. The transmission control logic of claim 10, wherein the queue weight determination logic comprises:
a first multiplexer (MUX) configured to increase a first queue weight register in response to receiving the respective queue-depletion indication;
a second MUX configured to decrease a second queue weight register in response to receiving the respective queue-overflow indication; and
a queue weight MUX coupled to the first queue weight register and the second queue weight register, wherein the queue weight MUX is configured to:
determine the respective queue weight according to the first queue weight register in response to receiving a first control signal from the first MUX; and
determine the respective queue weight according to the second queue weight register in response to receiving a second control signal from the second MUX.

12. The transmission control logic of claim 11, wherein:
the first MUX is configured to generate the first control signal in response to receiving a first threshold number of the respective queue-depletion indication; and
the second MUX is configured to generate the second control signal in response to receiving a second threshold number of the respective queue-overflow indication.

13. The transmission control logic of claim 1 integrated into an integrated circuit.

14. The transmission control logic of claim 1 integrated into a device selected from the group consisting of: a set top box; an entertainment unit; a navigation device; a communication device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

15. A means for mitigating head-of-line blocking (HOLB) in a communication device, comprising:
a means for monitoring one or more output queues in a communication device; and
a means for controlling one or more input queues configured to provide one or more output data streams to the one or more output queues, respectively;
for each of the one or more output queues:
the means for monitoring one or more output queues in a communication device is configured to:
measure a respective queue depth of the output queue;
compare the respective queue depth against a threshold to determine a state of the output queue; and
the means for controlling one or more input queues is configured to adjust a respective output data stream coupled to the output queue in response to the determination of the state of the output queue.

16. A method for mitigating head-of-line blocking (HOLB) in a communication device, comprising:
measuring a respective queue depth of an output queue among one or more output queues comprised in a communication device;
comparing the respective queue depth against a threshold to determine a state of the output queue; and
adjusting a respective output data stream among one or more output data streams coupled to the output queue in response to the determination of the state of the output queue.

17. The method of claim 16 further comprising:
comparing the respective queue depth against a queue-overflow threshold; and
decreasing the respective output data stream coupled to the output queue if the respective queue depth is greater than the queue-overflow threshold.

18. The method of claim 17 further comprising:
comparing the respective queue depth against a queue-depletion threshold; and
increasing the respective output data stream coupled to the output queue if the respective queue depth is less than the queue-depletion threshold.

19. The method of claim 18 further comprising measuring the respective queue depth periodically and generating a plurality of respective queue depths for the output queue.

20. The method of claim 19 further comprising:
for each of the plurality of respective queue depths:
increasing a queue-overflow counter if the respective queue depth is greater than the queue-overflow threshold; and
increasing a queue-depletion counter if the respective queue depth is less than the queue-depletion threshold; and
if the queue-overflow counter or the queue-depletion counter is greater than or equal to a predetermined hysteresis value:
generating a respective queue-overflow indication if the queue-overflow counter is greater than the queue-depletion counter; and
generating a respective queue-depletion indication if the queue-overflow counter is less than the queue-depletion counter.

21. The method of claim 20 further comprising resetting the queue-overflow counter and the queue-depletion counter after generating the respective queue-overflow indication or the respective queue-depletion indication.

22. The method of claim 18 further comprising providing the one or more output data streams from one or more input queues, respectively, based on a weighted round robin (WRR) scheduling scheme.

23. The method of claim 22 further comprising assigning one or more queue weights to the one or more input queues, respectively.

24. The method of claim 23 further comprising:
decreasing the respective output data stream coupled to the output queue by decreasing a respective queue weight associated with a respective input queue among the one or more input queues, wherein the respective input queue is configured to provide the respective output data stream; and
increasing the respective output data stream coupled to the output queue by increasing the respective queue weight associated with the respective input queue configured to provide the respective output data stream.
